(19) United States
(12) Patent Application Publication
(10) Pub. No.: US 2004/0137889 A1
(43) Pub. Date: Jul. 15, 2004

(54) Mass delivery communication system

(76) Inventor: Thomas E. Reidy, Cleveland, OH (US)

Correspondence Address: Cynthia S. Murphy, Renner, Otto, Boisselle & Sklar, LLP, Nineteenth Floor, 1621 Euclid Avenue, Cleveland, OH, 44115-2191, US

(21) Appl. No.: 10/674,754

(22) Filed: Sep. 30, 2003

Related U.S. Application Data
(60) Provisional application No. 60/417,390, filed on Oct. 9, 2002.

(51) Int. Cl. H04M 3/00

(52) U.S. Cl. 455/418

(57) ABSTRACT

A mass delivery communication system (10) for collecting and processing completion data of an item (12) that is to be mass delivered in a predetermined area (14) comprising a plurality of particular regions (16), each containing a plurality of delivery sites (18). In this system (10), at least one mobile terminal unit (20) is operationally disposed with delivery personnel and includes a transmitter for wireless transmission of delivery data. A processing center (22) is located remote from the mobile terminal unit (20) and includes a receiver for reception of the delivery data from the mobile terminal unit (20). The mobile terminal unit (20) is programmed to receive input regarding delivery completion in one of the particular regions (16) and to transmit delivery data corresponding to the input to the processing center (22). The processing center (22) is programmed to read, interpret, and display delivery data to appropriate parties via a host computer (24) and an Internet website (26).

### RELATED APPLICATIONS

This application claims priority under 35 U.S.C. § 119(e) to U.S. Provisional Patent Application No. 60/417,390, which was filed on Oct. 9, 2002. The entire disclosure of this earlier application is hereby incorporated by reference.

### FIELD OF THE INVENTION

This invention relates generally as indicated to a mass delivery communication system and, more particularly, to a system designed to accommodate the tracking and inspection needs of a mass delivery operation.

### BACKGROUND OF THE INVENTION

The use of wireless (e.g., cellular) communication systems having mobile devices which wirelessly communicate with a network to track the delivery of items has become commonplace in our society. For example, in the case of mail or packages, a particular item can be tracked from receipt to delivery at its final destination. This tracking information typically can be accessed selectively by the delivery company's administrators, by the customers contracting the delivery, and/or by the intended recipient.

In a mass delivery situation, the same item is delivered to a large number of sites (i.e., residences or businesses). Typically, a delivery person will drive to a specific region and then hand deliver the item to each residence on the street(s) in this region. In a mass delivery situation, the identification of individual addresses is not important, as every residence on a particular street is a potential delivery location. Also, since the same item is delivered to each home/business, an identification of each item sent to a particular address is not necessary. Consequently, systems which provide individual addresses and/or delivered item identification are superfluous, inefficient and essentially unworkable in a mass delivery situation.

### SUMMARY OF THE INVENTION

The present invention provides a communication system which is designed to accommodate the unique needs of a mass delivery situation. More particularly, the present invention provides a mass delivery communication system for collecting and processing the completion data for an item that is to be mass delivered in a predetermined area (e.g., a zip code) comprising a plurality of particular regions (e.g., street indexes), each containing a plurality of delivery sites (e.g., residential homes). The system comprises mobile terminal unit(s) operationally disposed with delivery personnel and including a transmitter for wireless transmission of delivery data. The processing center is located remote from the mobile terminal unit(s) and includes a receiver for receiving the delivery data from the mobile terminal unit. The mobile terminal unit(s) receive input regarding completion of delivery in one of the particular regions and transmit delivery data corresponding to the input to the processing center. The processing center is programmed to read, interpret, and display delivery data to appropriate parties.

Preferably, the mass delivery communication system comprises a host server located remote from the mobile terminal unit(s). The host server is operably connected to the Internet, and the delivery information is transferred to a website on the Internet. A password and/or a user identification may be necessary to access the delivery information on the Internet in order to ensure business confidentiality and/or for security purposes.

When using the mass delivery communication system, the same item is delivered to each of a plurality of delivery sites in a first region of the predetermined area. The completion of delivery to this area then is input into the mobile terminal unit, and this information is wirelessly communicated to the central processor. In this manner, administrative personnel can track delivery within this area. Also, the mass delivery communication system can be used simultaneously in a plurality of predetermined areas (e.g., a plurality of zip codes) to track the overall mass delivery process.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIG. 1 is a schematic top plan view of a mass delivery communication system according to the present invention.

FIG. 2 is a flow chart of the mass delivery communication system according to the present invention.

### DETAILED DESCRIPTION

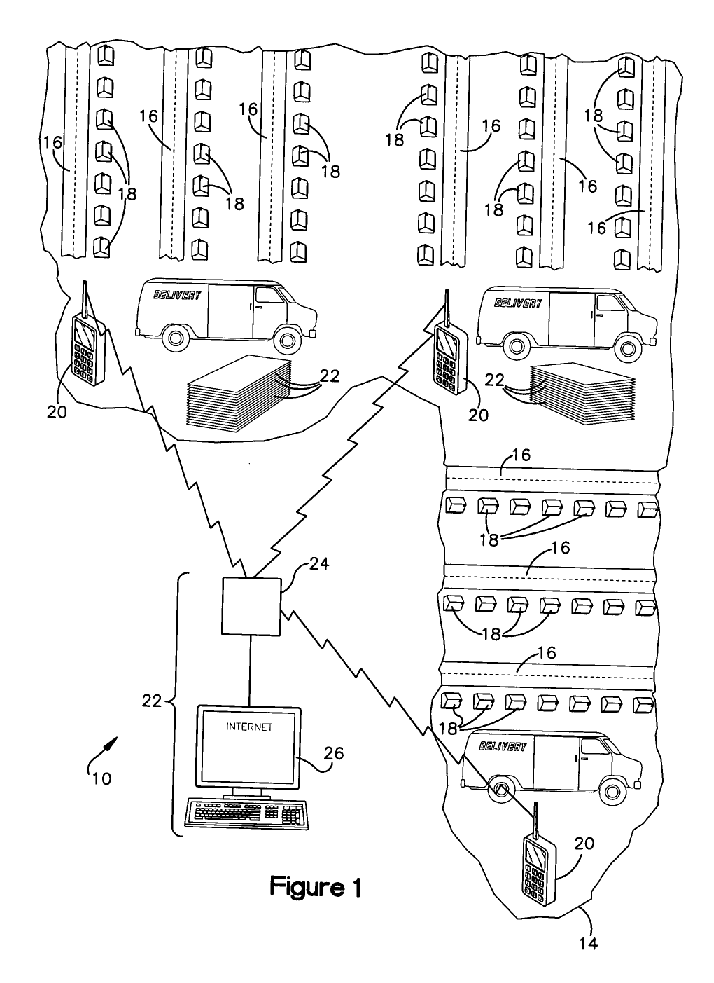

Referring now to the drawings in detail, and initially to FIG. 1, a mass delivery communication system 10 according to the present invention is schematically shown. The mass delivery communication system 10 collects and processes region completion data for a plurality of the same items 12 that are to be mass delivered in a predetermined area 14 comprising a plurality of particular regions 16, each containing a plurality of delivery sites 18. The system 10 comprises a plurality of mobile terminal units 20 (three terminals 20a, 20b and 20c in the illustrated embodiment) operationally disposed with delivery personnel and a processing center 22 located remote from the mobile terminal unit 12.

The mobile terminal units 20 each include a transmitter 24 for wireless transmission of delivery data, and the processing center 22 includes a receiver 26 for receiving the delivery data from the mobile terminal unit 20. This wireless transmittal can be accomplished, for example, through a wireless data network and/or a global positioning system (GPS). The mobile terminal units 20 each can also comprise a receiver and the processing center 22 can also comprise a transmitter, whereby the processing center 22 can wirelessly transmit information to the mobile terminal units 22. This further feature might be desirable, for example, for wirelessly loading a mobile terminal unit 22 with programming for a particular delivery job and/or for transmitting instructions to delivery personnel.

Each of the mobile terminal units 20 are programmed to receive input regarding delivery completion in one of the particular regions 16, and to transmit delivery data corresponding to the input to the processing center 22. The processing center 22 is programmed to read, interpret, and display delivery data to interested parties. Preferably, the processing center 22 includes a host server 24 located remote from mobile terminal units 20.

The host server 24 can be operably connected to the Internet and the delivery information transferred to a website on the Internet for viewing on a corresponding device 26. In this manner, the information can be accessed selectively by the delivery company's administrators and/or by the customers contracting the delivery. A password and/or user identification can be necessary to access the delivery information on the Internet in order to ensure business confidentiality and/or for security purposes.

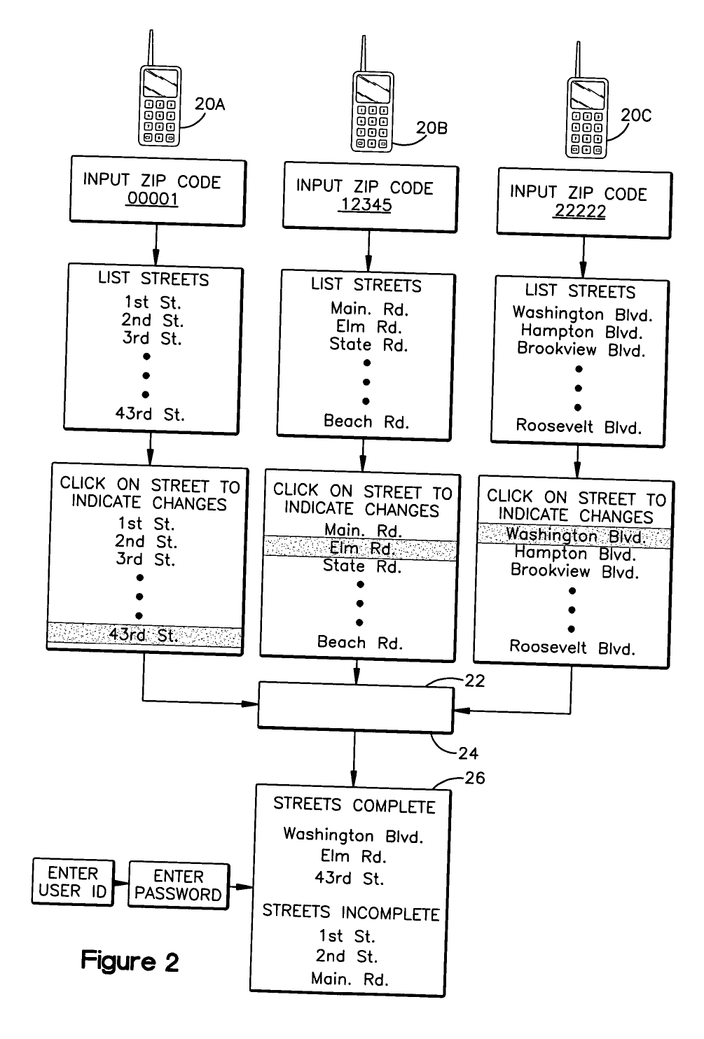

Referring now to FIG. 2, a method of using the mass delivery communication system is schematically shown. In the illustrated method, each mobile terminal unit 20 comprises a display screen. Delivery personnel input the relevant predetermined area 14 (which can conveniently be a zip code) and the mobile terminal unit 20 displays the particular regions 16 (which can conveniently be street indexes) within this area. The region 16 whereat delivery was completed is then input, preferably by scrolling down and “clicking” on the relevant region. This completion data is sent then to the processing device 22 which reads, interprets and displays delivery data to interested parties. Specifically, the information is transferred from a host computer 24 to the Internet, and a user identification and/or password is necessary to access the information at the website.

It may be noted that the mass delivery communication system 10 can be used in a plurality of predetermined areas (e.g., a plurality of zip codes). In this manner, the overall mass delivery process can be observed and tracked by administrative personnel. In fact, in many mass delivery situations only one mobile terminal unit 20 would be necessary per predetermined area (e.g., zip code). That being said, the mass delivery system 10 of the present invention provides the flexibility to divide delivery areas among delivery personnel in the most efficient and economic manner and to take into account such factors as different delivery rates, different delivery vehicles, and/or different delivery densities.

It also may be noted that the mass delivery communication system 10 can determine the predetermined area 14 (e.g., zip code) in ways other than personnel input. For example, if the system 10 uses a global positioning system (GPS), the predetermined area 14 could be determined simply by the location of the mobile terminal unit 20. In this case, delivery personnel simply would push an input causing the unit 20 to provides its location, and this location could be tracked to a predetermined area 14.

One now may appreciate that the present invention provides a route delivery communication system 10 which is designed to accommodate the unique needs of a mass delivery situation. Although the invention has been shown and described with respect to a certain preferred embodiment, equivalent and obvious alterations and modifications will occur to others skilled in the art upon the reading and understanding of this specification. The present invention includes all such alterations and modifications and is limited only by the scope of the following claims.

1. A mass delivery communication system for collecting and processing completion data for an item that is to be mass delivered in a predetermined area comprising a plurality of particular regions, each containing a plurality of delivery sites; said system comprising:
at least one mobile terminal unit operationally disposed with delivery personnel and including a transmitter for wireless transmission of delivery data; and
a processing center located remote from the mobile terminal unit and including a receiver for reception of the delivery data from the mobile terminal unit;
wherein the mobile terminal unit is programmed to receive input regarding completion of delivery in one of the particular regions and to transmit delivery data corresponding to the input to the processing center; and
wherein the processing center is programmed to read, interpret, and display delivery data to appropriate parties.

2. A mass delivery communication system, as set forth in the preceding claims, comprising a plurality of mobile terminal units, each unit being operationally disposed with delivery personnel and including a transreceiver for wireless communication of delivery data, and each unit being programmed to receive input regarding delivery completion of the item in a portion of the particular region and wherein the processing center is programmed to read, interpret, and display delivery data to appropriate parties.

3. A mass delivery communication system, as set forth in either of the preceding claims, wherein the processing center comprises a host server located remote from the mobile terminal unit(s).

4. A mass delivery communication system, as set forth in the preceding claim, wherein the host server is operably connected to the Internet and the delivery information is transferred to a website on the Internet.

5. A mass delivery communication system, as set forth in the preceding claim, wherein a password is necessary to access the delivery information on the Internet.

6. A mass delivery communication system, as set forth in either of the preceding claims, wherein an user identification is necessary to access the delivery information on the Internet.

7. A mass delivery communication system, as set forth in any of the preceding claims, wherein the mobile terminal unit also comprises a receiver; wherein the processing center comprises a transmitter; and wherein the processing center wirelessly transmits information to the mobile terminal unit.

8. A mass delivery communication system, as set forth in any of the preceding claims, wherein the mobile terminal unit comprises a display screen; wherein the mobile terminal unit is programmed to display a menu on the screen; and wherein the menu includes an input for the predetermined area.

9. A mass delivery communication system, as set forth in the preceding claim, wherein the mobile terminal unit is programmed so that the input is a zip code.

10. A mass delivery communication system, as set forth in any of claims 1-7, wherein the mobile terminal unit receives input from a global positioning system to determine the relevant predetermined area.

11. A mass delivery communication system, as set forth in claim 10, wherein the relevant predetermined area is a zip code.

12. A mass delivery communication system, as set forth in any of the preceding claims, wherein the mobile terminal unit displays the particular regions within the predetermined area.

13. A mass delivery communication system, as set forth in the preceding claim, wherein the particular regions are street indexes.

14. A mass delivery communication system, as set forth in either of the preceding claims, wherein the input is performed by selecting one of the displayed particular regions.

15. A method of using the mass delivery communication system, as set forth in any of the preceding claims, said method comprising the steps of:
delivering the same item to each of a plurality of delivery sites in a first particular region of a predetermined area comprising a plurality of particular regions; and
inputting delivery completion in the first particular region into the mobile terminal unit.

16. A method, as set forth in the preceding claim, further comprising the step of viewing the delivery data via the processing center.

17. A method of collecting and processing delivery completion data, said method comprising the steps of:
delivering the same item to each of a plurality of delivery sites in a first particular region of a predetermined area comprising a plurality of particular regions; and
inputting delivery completion in the first particular region into a mobile terminal unit operationally disposed with delivery personnel;
transmitting delivery data corresponding to the input to a processing center located remote from the mobile terminal unit; and
reading, interpreting, and displaying the delivery data to appropriate parties.

18. A method as set forth in the preceding claim, further comprising the steps of:
delivering the same item to each of a plurality of delivery sites in a first particular region of a predetermined area comprising a plurality of particular regions; and
inputting delivery completion in each of the particular regions into mobile terminal unit(s) operationally disposed with delivery personnel;
transmitting delivery data corresponding to the input to a processing center located remote from the mobile terminal unit(s); and
reading, interpreting, and displaying the delivery data to interested parties.

19. A method, as set forth in either of the preceding claims, wherein said transmitting step comprises transmission of the delivery data to a host server located remote from the mobile terminal unit(s).

20. A method, as set forth in the preceding claim, wherein said displaying step comprises the transfer of delivery information to a website on the Internet.

21. A method, as set forth in the preceding claim, further comprising the step of accessing the delivery information on the Internet, and wherein a password and/or a user identification is necessary for this access.

22. A method, as set forth in any of claims 17-21, further comprising the step of wireless transmission of information to the mobile terminal unit(s).

23. A method, as set forth in any of claims 17-22, wherein said inputting step comprises the display of a menu which includes an input for the predetermined area.

24. A method, as set forth in any of claims 17-23, wherein said inputting step comprises the input of a zip code.

25. A method, as set forth in either of the preceding claims, wherein the mobile terminal unit displays the particular regions within the predetermined area.

26. A method, as set forth in the preceding claim, wherein the particular regions are street indexes.

27. A method, as set forth in any of claims 17-26, wherein said inputting step comprises the selection of one of the displayed particular regions.

28. A mass delivery communication system for collecting and processing delivery completion for an item that is to be mass delivered in predetermined areas, each comprising a plurality of particular regions each containing a plurality of delivery sites; said system comprising:
a mobile terminal unit operationally disposed in each of the predetermined areas; and
a processing center located remote from the mobile terminal units;
wherein each of the mobile terminal units is programmed to receive input regarding delivery completion in the corresponding particular region and to transmit delivery data corresponding to the input to the processing center; and
wherein the processing center is programmed to read, interpret, and display delivery data to appropriate parties.

29. A mass delivery communication system, as set forth in the preceding claim, wherein the processing center comprises a host server located remote from the mobile terminal unit(s).

30. A mass delivery communication system, as set forth in the preceding claim, wherein the host server is operably connected to the Internet and the delivery information is transferred to a website on the Internet.

31. A mass delivery communication system, as set forth in any of claims 28-31, wherein the predetermined areas each comprise a zip code.

32. A mass delivery communication system, as set forth in any of claims 26-29, wherein the particular regions comprise street indexes.

33. A mass delivery communication system, as set forth in any of claims 28-33, wherein the delivery sites comprise residential homes.
